(19) United States
(12) Patent Application Publication
(10) Pub. No.: US 2017/0179768 A1
(43) Pub. Date: Jun. 22, 2017

(54) PORTABLE CHARGING SYSTEM AND HYBRID BATTERY

(71) Applicant: CGG SERVICES SA, Massy Cedex (FR)

(72) Inventor: Jason JUROK, East Grinstead (GB)

(21) Appl. No.: 15/304,918

(22) PCT Filed: Mar. 4, 2015
(86) PCT No.: PCT/IB2015/000509

§ 371 Date: Oct. 18, 2016

Related U.S. Application Data
(60) Provisional application No. 61/983,486, filed on Apr. 24, 2014.

(51) Int. Cl. H02J 50/12; H02J 50/80; H02J 7/00; H02J 7/02

(52) U.S. Cl. CPC H02J 50/12; H02J 7/025; H02J 50/80; H02J 7/0042; H02J 7/345

(57) ABSTRACT

A portable charging system has a first part with an electrical power source and a first housing having a first three dimensional shape. A second part that is separate from and independent of the first part has a second housing with a second three dimensional shape comprising a complementary shape to the first three dimensional shape and a charge storage unit containing an ultracapacitor. The charge storage unit is disposed in the second housing. The first three dimensional shape mates with the second three dimensional shape to align the first part with the second part to facilitate wireless transfer of power from the electrical power source to the charge storage unit for storage in the ultracapacitor.

### CROSS-REFERENCE TO RELATED APPLICATIONS

This application claims priority from, U.S. Provisional Patent Application No. 61/983,486, filed on Apr. 24, 2014, entitled “Hybrid Battery”, the entire disclosure of which is incorporated herein by reference.

### TECHNICAL FIELD

Embodiments of the subject matter disclosed herein generally relate to portable battery recharging systems.

### BACKGROUND

Seismic data acquisition systems use re-chargeable batteries to provide long term energy for field digitizing units. These re-chargeable batteries need to be recharged in the field. Typical geophysical prospects grow in size every year, making access to the re-chargeable batteries increasingly difficult and time consuming. In fact, the use of helicopters and other alternative transportation mechanisms are being used to access the re-chargeable batteries across large and remote areas.

Re-chargeable energy storage devices, hereinafter referred to as re-chargeable batteries, incorporate technologies ranging from traditional electro-chemical cells to ultra or super high value capacitor batteries. Regardless of the technology employed all re-chargeable batteries have a finite storage capacity and at some point need to be re-charged. Currently, in seismic acquisition system applications, the re-chargeable batteries are retrieved from the field and are transported to a charger. This process which requires a large, static, location, e.g. a battery shack, with enough space and electrical capacity to re-charge a significant number of batteries simultaneously. The size of the charging location, electrical capacity and number of batteries available for simultaneous charging are dictated by the amount of time required to charge a single electrochemical battery as well as the requirement to heat and or cool the cells in order to facilitate bulk charge currents. The number of additional batteries in excess of the batteries being simultaneously charged is limited, requiring an almost continuous movement of re-chargeable batteries in and out of the field.

Therefore, systems and methods are desired to re-charge these re-chargeable batteries in-situ or in the field without having to physically retrieve each battery and transport the battery to a central charging station.

### SUMMARY

Exemplary embodiments are directed to a portable charging system that can re-charge batteries in the field. The portable charging system can be used as a replacement for existing re-chargeable batteries or can be used to charge existing re-chargeable batteries in the field. The portable charging system can be used with mechanized transportation equipment including helicopters and can also be transported by sled. In one embodiment, the portable charging system utilizes power storage devices having a higher than normal power density for faster charging. The portable charging system simplifies field operations, reduces the overall number of re-chargeable batteries required and reduces the crew footprint. In addition, the infrastructure needed for static charging stations is reduced significantly.

One exemplary embodiment is directed to a portable charging system having a first part with an electrical power source and a first housing having a first three dimensional shape. Suitable electrical power sources include, but are not limited to, a generator, aircraft power, a battery, an alternator, a fuel cell, a piezoelectric generator, a wave generator, a thermoelectric generator, a photovoltaic cell and combinations thereof. The first part further can also include a first electrical coil disposed in the first housing and in communication with the electrical power source and a first wireless communication module disposed in the first housing.

A second part is provided that is separate from and independent of the first part. The second part includes a second housing having a second three dimensional shape that is a complementary shape to the first three dimensional shape. The second part also includes a charge storage unit disposed in the second housing and containing an ultracapacitor. A second electrical coil is disposed in the second housing and in communication with the charge storage unit. In one embodiment, the second electrical coil includes a magnetic core. In one embodiment, the second part also contains an electrochemical cell in communication with the ultracapacitor. The ultracapacitor charges the electrochemical cell. A second wireless communication module is disposed in the second housing,

The first three dimensional shape mates with the second three dimensional shape to align the first part with the second part to facilitate wireless transfer of power from the electrical power source to the charge storage unit for storage in the ultracapacitor. For example, the first electrical coil and the second electrical coil wirelessly transfer power through inductive coupling when the first three dimensional shape is mated with the second three dimensional shape. Preferably, the first electrical coil and the second electrical coil are resonant circuits that resonate at a common frequency. In one embodiment, the first electrical coil is coaxial with the second electrical coil and the second electrical coil is nested within the first electrical coil when the first three dimensional shape is mated with the second three dimensional shape.

The second three dimensional shape is at least partially disposed within the first three dimensional shape when the first three dimensional shape is mated with the second three dimensional shape. In addition, the first wireless communication module exchanges data with the second wireless communication module when the first three dimensional shape is mated with the second three dimensional shape. Suitable first and second wireless communication modules include, but are not limited to, radio wave communication modules, ultrasonic communication modules, inductive coupling communication modules, optical communication modules, cellular network communication modules and acoustic communication modules.

In one embodiment, the first three dimensional shape has rotational symmetry about a first axis, and the second three dimensional shape has rotational symmetry about a second axis. The first axis and the second axis form a common axis when the first three dimensional shape is mated with the second three dimensional shape. In one embodiment, the first three dimensional shape and the second three dimensional shape have rotational symmetry with respect to any angle of rotation. Preferably, mating of the first three dimensional shape with the second three dimensional shape and wireless transfer of power from the electrical power source to the charge storage unit is agnostic to rotation of the first part with respect to the second part about the common axis.

In one embodiment, the charge storage unit in the second part is in communication with remotely deployed field equipment to provide power to the field equipment. In another embodiment, the charge storage unit in the second part is in communication with a field battery in a seismic data acquisition system to charge the field battery. The field battery is in communication with ground equipment in the seismic data acquisition system to provide power to the ground equipment.

Exemplary embodiments are also directed to a seismic data acquisition system containing ground equipment that includes at least one surface unit in communication with at least one seismic sensor for obtaining seismic data, a field battery in communication with the surface unit to provide power to the surface unit and a portable charging system in communication with the field battery to charge the field battery. The portable charging system includes a first part having an electrical power source and a first housing having a first three dimensional shape. The portable charging system also includes a second part separate from and independent of the first part. The second part includes a second housing having a second three dimensional shape that is a complementary shape to the first three dimensional shape and a charge storage unit containing an ultracapacitor. The charge storage unit is disposed in the second housing and is in communication with the field battery. The first three dimensional shape mates with the second three dimensional shape to align the first part with the second part to facilitate wireless transfer of power from the electrical power source to the charge storage unit for storage in the ultracapacitor.

Exemplary embodiments are also directed to a method for charging remotely deployed field equipment. An electrical power source is combined with a first housing having a first three dimensional shape. A charge storage unit is deployed at a remote location. This charge storage unit includes an ultracapacitor that is disposed within a second housing having a second three dimensional shape. The first housing is transported to the remote location, and the first three dimensional shape is mated with the second three dimensional shape to facilitate wireless transfer of power from the electrical power source to the charge storage unit for storage in the ultracapacitor. In one embodiment, the first three dimensional shape has rotational symmetry about a first axis, and the second three dimensional shape has rotational symmetry about a second axis. Mating the first three dimensional shape with the second three dimensional shape aligns the first axis with the second axis to form a common axis when the first three dimensional shape is mated with the second three dimensional shape.

In one embodiment, the method also includes incorporating a first wireless communication module in the first housing, incorporating a second wireless communication module in the second housing and exchanging data between the first wireless communication module and the second wireless communication module when the first three dimensional shape is mated with the second three dimensional shape. In another embodiment, the method also includes incorporating a first electrical coil in the first housing in communication with the electrical power source, incorporating a second electrical coil in the second housing in communication with the charge storage unit and mating the first three dimensional shape with the second three dimensional shape by coaxially aligning the first electrical coil and the second electrical coil to transfer wirelessly power through resonant inductive coupling when the first three dimensional shape is mated with the second three dimensional shape.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 is a schematic representation of an embodiment of a portable charging system in accordance with the present invention;

FIG. 2 is a side elevation view of an embodiment of a the portable charging system;

FIG. 3 is an exploded bottom perspective view of the embodiment of the portable charging system;

FIG. 4 is an exploded cut-away top perspective view of the embodiment of the portable charging system;

FIG. 5 is an exploded side elevation cut-away view of the embodiment of the portable charging system;

FIG. 6 is a schematic view of an embodiment of a seismic data acquisition system incorporating the portable charging system; and

FIG. 7 is a flow chart illustrating an embodiment of a method for using the portable charging system to charge remotely deployed field equipment.

### DETAILED DESCRIPTION

The following description of the embodiments refers to the accompanying drawings. The same reference numbers in different drawings identify the same or similar elements. The following detailed description does not limit the invention. Instead, the scope of the invention is defined by the appended claims. Some of the following embodiments are discussed, for simplicity, with regard to local activity taking place within the area of a seismic survey. However, the embodiments to be discussed next are not limited to this configuration, but may be extended to other arrangements that include regional activity, conventional seismic surveys, etc.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

Exemplary embodiments provide a portable charging system that is transported into the field to either re-chargeable batteries or equipment that contains rechargeable batteries. Exemplary embodiments are also directed to seismic data acquisition systems and the components of the seismic data acquisition system that incorporate the portable charging system. In one embodiment, the portable charging system is used in combination with an existing charge storage unit or battery, existing ground equipment or existing nodes to power the existing equipment or re-charge the batteries in the equipment in the field or in-situ. Alternatively, existing equipment can be modified or customized to incorporate the portable charging system.

The portable charging system eliminates or significantly reduces the need for conventional static charging locations, the associated equipment and the need to transport re-chargeable batteries to these static charging locations. The batteries and the nodes are not transported to the static charging locations. Instead, the portable charging system is transported to the location of the equipment or batteries in accordance with a frequency or schedule that maintains the desired level of charge in the field deployed batteries. In addition, the amount of time spent at any given location depends on the amount of charge delivered, i.e., a full or complete “top up” charge or only a partial charge. In one embodiment, the frequency of charging and the length of time spent charging any given battery is determined based on a cost/benefit ratio that varies from seismic survey job to seismic survey job.

Exemplary embodiments leverage the power density and rapid charging found in batteries that utilize capacitors to store energy. Preferably, these capacitors are super or ultracapacitors. In one embodiment, the ultracapacitors are used alone, eliminating the need for conventional electro-chemical batteries and the associated re-charging infrastructure. Alternatively, the ultracapacitor charge storage unit or battery is used in combination with a conventional electro-chemical charge storage unit or battery in order to combine the power density of ultracapacitors with the energy density of electro-chemical batteries.

As an ultracapacitor uses capacitance to store energy, this energy is acquired, stored and possibly discharged at a higher rate than conventional types of rechargeable batteries. A typical ultracapacitor charge storage unit or battery includes electrochemical capacitors that store energy electrostatically by polarizing an electrolytic solution. An electrode is disposed in the electrolytic solution to function as the first capacitor plate. The electrolyte ions from the electrolytic solution function as the second capacitor plate. Suitable electrodes include, but are not limited to, porous carbon-based electrode materials and polymer compound based electrodes. In one embodiment, the electrode is a graphene-based electrode, which provides an ultracapacitor charge storage unit or battery with an energy density comparable to current electro-chemical rechargeable batteries such as Nickel-Metal Hydride (NiMH) batteries.

When voltage is applied to the electrode that is suspended in the electrolyte, the electrolyte is polarized and the electrolyte ions move to the electrode. The distance of separation between the electrode and the electrolyte ions is the distance of separation of the two capacitor plates, which is on the order of Angstroms. This distance of separation yields a capacitance per unit area orders of magnitude greater than conventional capacitors. Additional embodiments of ultracapacitors utilize a pair of oppositely charged electrodes, with electrolytes of different polarities being attracted to the corresponding electrode.

Conventional electro-chemical batteries have high energy densities and low power densities. Suitable electrochemical batteries include, but are not limited to, NiMH batteries, Nickel Cadmium (NiCad) batteries and Lithium Ion batteries. Given a high energy density and low power density, the electro-chemical batteries provide sufficient capacity for low drain applications. Such low drain applications are typical in the equipment use in geophysical or seismic data acquisition systems. The limiting factor of the electro-chemical batteries is a rate at which this capacity can be taken from or applied to the charge storage unit or battery, i.e., the rate at which the electro-chemical charge storage unit or battery can be recharged. In order to minimize the time spent in the field at any given charge storage unit or battery during the re-charging process, higher power density charge storage unit or battery components are utilized. This higher power density component is the charge storage unit or battery containing the ultracapacitor. Electrical energy is transferred to the ultracapacitor and stored. This energy is then used as a power source. Alternatively, this energy is transferred to an electro-chemical charge storage unit or battery in a controlled manner after the ultracapacitor has been charged. Including both the high power density component and the high energy density component produces a “Hybrid Battery”, where the device with the high power density component is the ultracapacitor. In one embodiment, the high power density component and the high energy density component are incorporated into a single device or charge storage unit or battery. Alternatively, these components are provided in separate devices, for example when the portable charging system is used with existing batteries.

Advantages of ultracapacitor batteries in addition to their rapid charging capabilities include improved cold weather performance and longer life spans. Pairing batteries containing ultracapacitors with electro-chemical batteries through an appropriate electrical interface provides for in-situ recharging as the ultracapacitor is rapidly charged and the electro-chemical charge storage unit or battery is subsequently slowly charged using energy from the capacitor.

The portable charging system increases the power density of the electrical energy transfer. In general, electrical power has two components, voltage and current. Raising one or both of these components increases power density. High voltage can be dangerous to work around, and high current requires the use of sturdier hardware, which can result in potential reliability issues. In the portable charging system electrical energy applied to the ultracapacitor is relatively high while the current is maintained a reasonable level through the use of a higher than normal voltage that is still within safe operating conditions. In one embodiment, the resultant charge on the ultracapacitor is fed to the equipment or to an electrochemical charge storage unit or battery using appropriate circuitry including a highly efficient voltage regulator and a battery charger module. Therefore, rechargeable batteries are maintained in place and charged without having to remove the charge storage unit or battery, transport the charge storage unit or battery to a central recharging station and to have extra batteries sitting unused for long periods of time. This yields increased productivity and reduced downtime.

Exemplary applications of the portable recharging system include charging seismic nodes in the field, charging the field batteries in a cable-based seismic survey and charging the battery of a floating digital acquisition unit (DAU) buoy. The portable charging system can also be used in the Microseismic realm to rapidly charge DAU boxes, therefore limiting the need for larger battery charging infrastructure.

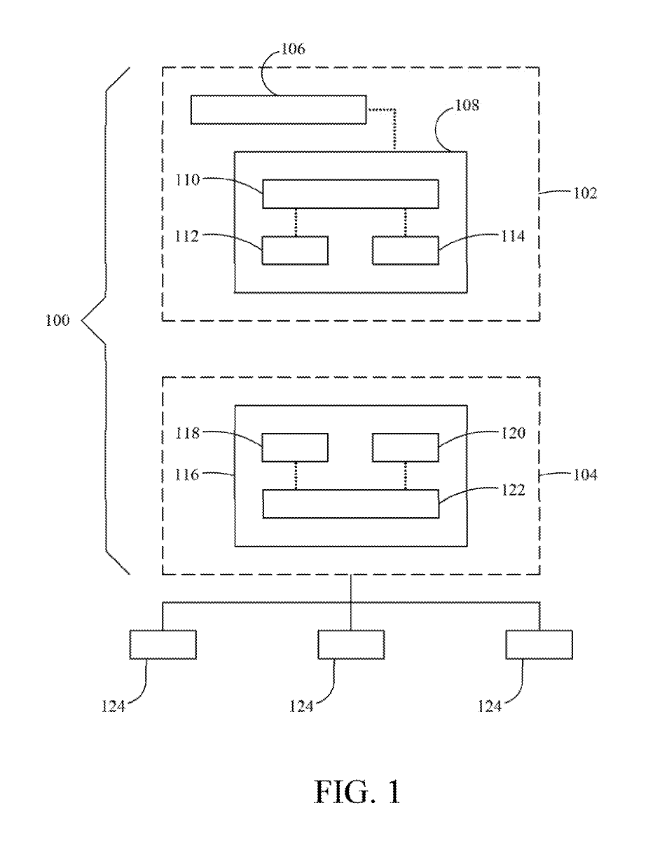

Referring initially to FIG. 1, an exemplary embodiment of a two-part portable charging system 100 is illustrated. The portable charging system includes a first part 102 and second part 104 that is separate from and independent of the first part. The first part includes at least one electrical power source 106 and a first housing 108. The power source can be internal to the first housing or external to the first housing. Suitable electrical power sources include, but are not limited to, a generator, aircraft power, a charge storage unit or battery (capacitor or electro-chemical), an alternator, a fuel cell, a piezoelectric generator, a wave generator, a thermoelectric generator, a photovoltaic cell and combinations thereof.

In one embodiment, the first part includes at least one first electrical coil 112, i.e., an inductive coil, disposed in the first housing 108 and in communication with the electrical power source. The first part further also include a first wireless communication module 114 disposed in the first housing. Suitable wireless communication modules include, but are not limited to, radio wave communication modules, ultrasonic communication modules, inductive coupling communication modules, optical communication modules, cellular network communication modules and acoustic communication modules.

The first part can also include additional electronics 110 within the housing including additional batteries (capacitor and electro-chemical, charge control electronics, an AC transformer, a DC/AC inverter, inductor drive circuitry, resonant circuit devices (HR-WPT), data storage components and audible and visual indicators, i.e., visible from the exterior of the housing, to show the units status. In one embodiment, the first part includes alternative storage devices, for example super or ultracapacitors, to compensate for an in-rush current load placed on the electrical power source. In addition, circuitry is provided to determine how and when the temporary charge in the ultracapacitor is transferred or applied to either the load, i.e., seismic data acquisition equipment, directly or to a secondary energy storage device for charging, i.e., a second electrochemical charge storage unit or battery. For example, this circuitry can be set up on a schedule, be instructed to be mindful of battery temperature or to manage which, of possibly multiple, batteries get charged, avoiding such things as the impact of the load on the charge algorithms.

The first part is mobile or transportable and is transported into the field to be mated with the second part in order to wirelessly transfer power from the power source to the second part. The portable charging system transfers energy in a safe and easy manor with no exposed, conductive, electrical connections or user intervention required. The portable charging system and the components of the portable charging system are scalable to accomplish in-situ charging where the first part is carried by hand, transported or pulled on a sled or transported by a vehicle or aircraft such as a helicopter or drone.

The housing of the first part is sized and configured in accordance with the desired mode or transport and to minimize the need for user interaction or complicated alignment of parts. For example, the first housing can be configured with a main body having a sealed end cap and any necessary interior bracing and mounting plates. Anchor points, handles, wheels and runners can also be provided to facilitate the mode of transport. In general, the first housing has a first three dimensional shape. This first three dimensional shape has rotational symmetry around at least a first axis passing through the first housing. Preferably, this rotational symmetry is with respect to angle of rotation about the first axis, e.g., spherical rotational symmetry.

The second part 104 is separate from and independent of the first part and includes a second housing 116 and a charge storage unit or battery 122 containing an ultracapacitor disposed in the second housing. The second part also includes a second electrical coil 118, inductive coil, disposed in the second housing and in communication with the charge storage unit or battery. The first electrical coil and the second electrical coil wirelessly transfer power through inductive coupling between the first and second parts and in particular, between the electrical power source 106 and the charge storage unit or battery 122 when the first and second housing are in proximity to each other. Preferably, the first electrical coil and the second electrical coil are resonant circuits that resonate at a common frequency. In one embodiment, the second electrical coil includes a ferrite core to concentrate the magnetic field.

In one embodiment, the charge storage unit or battery of the second part can also include an electrochemical cell in communication with the ultracapacitor. The ultracapacitor charges the electrochemical cell after receiving electrical power from the electrical power source. In one embodiment, the second part includes additional electronics 120 disposed within the housing. In one embodiment, these additional electronics include a second wireless communication module. The first wireless communication module exchanges data with the second wireless communication module when the first and second housings are in proximity to each other. Suitable wireless communication modules include, but are not limited to, radio wave communication modules, ultrasonic communication modules, inductive coupling communication modules, optical communication modules, cellular network communication modules and acoustic communication modules.

The additional electronics 120 can also include additional batteries (capacitor and electro-chemical, charge control electronics, an AC transformer, a DC/AC inverter, inductor drive circuitry, resonant circuit devices (HR-WPT), data storage components and audible and visual indicators, i.e., visible from the exterior of the housing, to show the units status. In addition, circuitry is provided to determine how and when the temporary charge in the ultracapacitor is transferred or applied to either the load, i.e., seismic data acquisition equipment, directly or to a secondary energy storage device for charging, i.e., a second electrochemical charge storage unit or battery. For example, this circuitry can be set up on a schedule, be instructed to be mindful of battery temperature or to manage which, of possibly multiple, batteries get charged, avoiding such things as the impact of the load on the charge algorithms.

The second housing has a second three dimensional shape that is a complementary shape to the first three dimensional shape. Therefore, the first three dimensional shape mates with the second three dimensional shape to align the first part with the second part to facilitate wireless transfer of power from the electrical power source to the charge storage unit or battery for storage in the ultracapacitor and wireless communication between the first part and the second part. The second three dimensional shape has rotational symmetry about a second axis. Preferably, this rotational symmetry is with respect to any angle of rotation around the second axis, e.g., spherical rotational symmetry. The second three dimensional shape can be either completely or partially disposed within the first three dimensional shape when the first three dimensional shape and the second three dimensional shape are mated together.

Mating the first and second three dimensional shapes places the first and second coils in proper alignment for inductive power transfer between the first and second units. In one embodiment, when the first three dimensional shape is mated with the second three dimensional shape, the first axis and the second axis form a common axis. The axes, i.e., the magnetic axes, of the first and second coils are then aligned along this common axis. Therefore, the first and second coils are coaxial. In one embodiment, the second electrical coil is nested within the first electrical coil.

The second part is disposed in the field, and the first part is transported to the second part to charge the charge storage unit or battery. In one embodiment, the charge storage unit or battery 122 in the second part 104 is in communication with ground equipment 124 in a seismic data acquisition system to provide power to the ground equipment. The field equipment can include a plurality of units, for example, a plurality of surface units, field digitizer units or nodes. Other seismic data acquisition systems include one or more field batteries that provide power to the ground equipment. The portable charging system is used to re-charge these field batteries. Therefore, the charge storage unit or battery in the second part is in communication with a field battery in a seismic data acquisition system to charge the field battery.

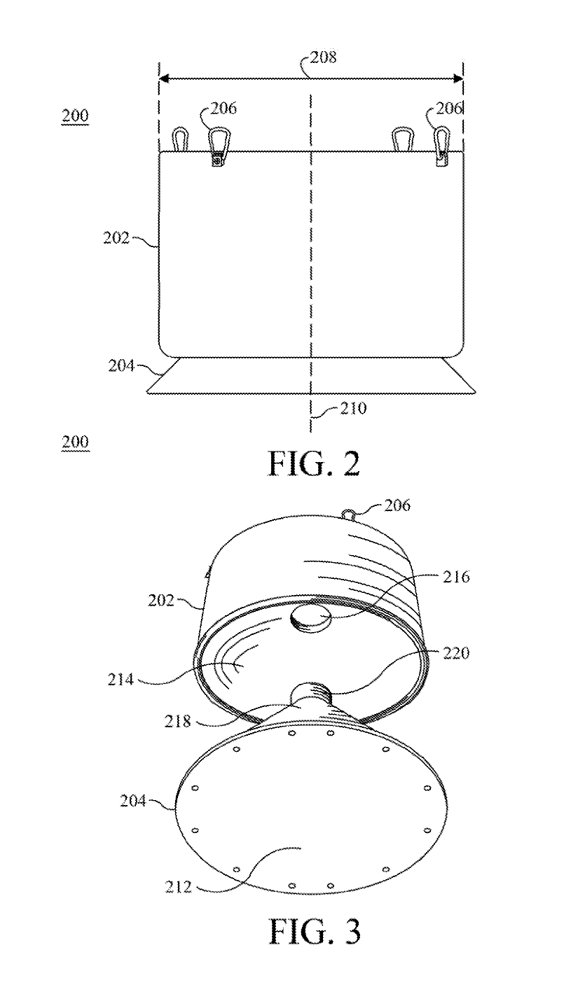

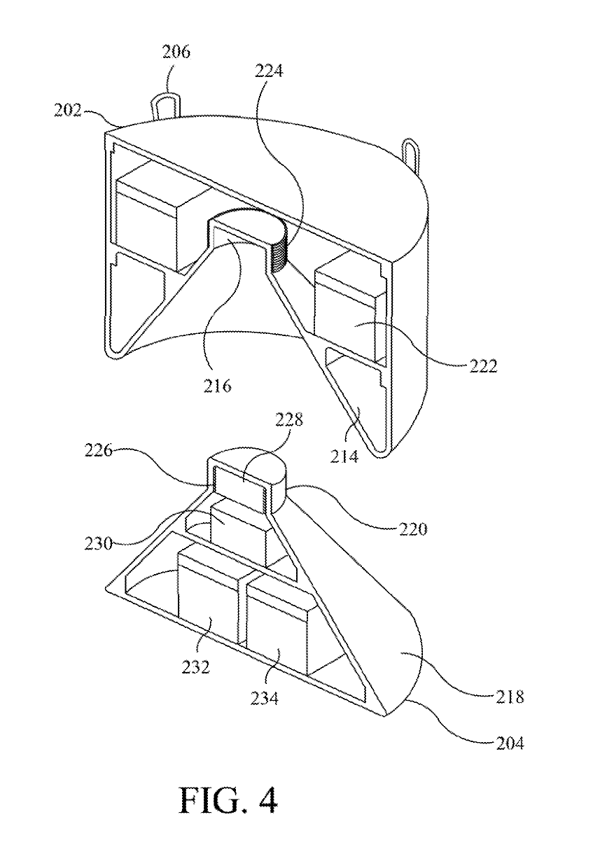

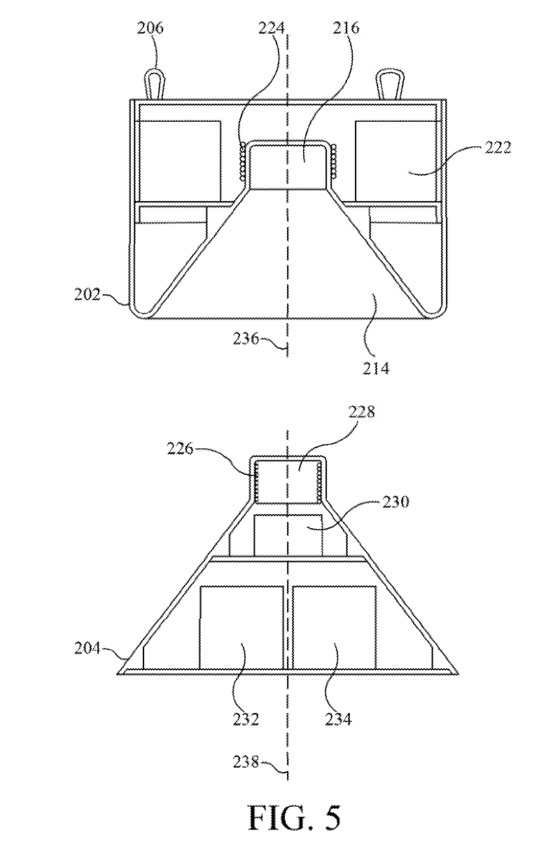

Referring to FIGS. 2-5, an exemplary embodiment of the portable charging system 200 is illustrated. The embodiment as illustrated is a large scale version of the invention intended for use with a helicopter. The portable charging system, however, is scalable and the same basic shape, the same basic arrangement of components or other shapes and arrangements are possible, including arrangements that can be easily pulled by man-power on a sled or trolley.

The portable charging system includes a first part that includes an electrical power source (not shown) and a first housing 202 having a first three dimensional shape. The electrical power source can be included within the first housing or can be external to the housing and provided through a power cable. As illustrated, the first housing is attached to a helicopter or drone by one or more cables attached to anchors 206 extending from the first housing. The location and arrangement of the anchors provides for the proper orientation of the first housing for mating with the other components of the portable charging system. The source of electrical power is the engine of the helicopter or a generator on the helicopter, and the power cable would extend down and into the first housing to connect with the electric components within the first housing.

The three dimensional shape of the first housing has rotational symmetry about at least a first axis 236. Preferably, this rotational symmetry is with respect to any angle of rotation around the first axis. The first three dimensional shape can include the entire housing or only a portion of the housing. As illustrated, the three dimensional shape includes a cavity or concave portion of the first housing having an internal conical portion 214 and an internal cylindrical portion 216, both of which are preferably coaxial with the first axis 236. Other shapes can also be utilized, for example, an internal square box shape. The outer portion of the first housing is illustrated as generally cylindrical. However, other shapes are possible, and this portion of the first housing does not have to include the same rotational symmetry.

A first electrical coil 224 is disposed within the first housing and is in communication with the electrical power source. Preferably, the first electrical coil extends around the internal cylindrical portion. Therefore, the first electrical coil, or the magnetic axis of the first electrical coil, is coaxial with the first axis. Also included within the first housing is all of the additional electronics 222 of the first part. These additional electronics are discussed above and include a first wireless communication module.

The second part is separate from and independent of the first part, and is the part that is located and resident in the field. The second part includes a second housing 204 having a second three dimensional shape that is a complementary shape to the first three dimensional shape. This three dimensional shape can include the entire second housing or a portion of the second housing. The second three dimensional shape is generally external or convex and includes an external conical section 218 and an external cylindrical section 220. The second three dimensional shape has rotational symmetry about a second axis 238, preferably with respect to all angles around the second axis 238. The second housing 204 also includes a flat bottom portion 212. This is the portion that is in contact with the ground and can be arranged as a removable portion to provide access to the internal components of the second housing.

The second part also includes a second electrical coil 226. This electrical coil is preferably contained within the external cylindrical portion 220 of the second housing. This second electrical coil is arranged coaxial with the external cylindrical portion and, therefore, the second axis 238. Therefore, the magnetic axis of the second electrical coil extends along the second axis. In one embodiment, a ferrite or magnetic core 228 is provided inside the second electrical coil 226 to concentrate the magnetic fields.

The second part includes a charge storage unit or battery having an ultracapacitor 232 that is disposed in the second housing. In one embodiment a second charge storage unit or battery 234 is also provided within the second housing. This second charge storage unit or battery is an electro-chemical charge storage unit or battery that is in communication with the ultracapacitor charge storage unit or battery. The ultracapacitor charge storage unit or battery charges the electro-chemical charge storage unit or battery. The additional electronics 230 as described above are also included within the second housing in communication with the charge storage unit or battery 232. In one embodiment, these additional electronics include a second wireless communication module.

The first three dimensional shape mates with the second three dimensional shape. This aligns the first part with the second part to facilitate wireless transfer of power from the electrical power source to the charge storage unit or battery for storage in the ultracapacitor and to facilitate the exchange of data between the first wireless communication module and the second wireless communication module. When the first and second housings or the first and second three dimensional shapes are mated together, the second three dimensional shape is at least partially disposed within the first three dimensional shape (FIG. 2). In addition, the first axis and the second axis align to form a common axis 210. The first and second electrical coils are coaxial with this common axis. In one embodiment, the external cylindrical portion of the second housing extends into the internal cylindrical portion of the first housing. Therefore, the first electrical coil is not only coaxial with the second electrical coil when the first three dimensional shape is mated with the second three dimensional shape, but the second electrical coil is nested within the first electrical coil. The first and second electrical coils, therefore, can exchange electrical power through inductive coupling. Preferably, this inductive coupling is resonant inductive coupling as both of the coils resonate at a common frequency. This resonant inductive coupling includes Highly Resonant Wireless Power Transfer (HR-WPT).

The first and second three dimensional shapes and the rotational symmetry of the first and second three dimensional shapes facilitate easy and mechanized mating of the first and second housings in the field as the complementary conical shapes will guide the first and second housing into contact and alignment. In addition, mating of the first three dimensional shape with the second three dimensional shape and wireless transfer of power from the electrical power source to the charge storage unit or battery is agnostic to rotation of the first part with respect to the second part about the common axis. Therefore, no special polarity has to be achieved or alignment mechanisms utilized to facilitate wireless power and data exchange.

Therefore, exemplary embodiments utilize the power transfer benefits of ultracapacitors in combination with the shape of two mating housings. This facilitates semi-blind mating where visibility from an aircraft is limited, for example when extending through a canopy of trees. No special alignment or latching is required. The wireless power transfer eliminates electrical contacts leads, increasing reliability as all circuitry remains sealed within the respective housings. The portable charging system is also safer to operate or use in adverse wind and weather conditions.

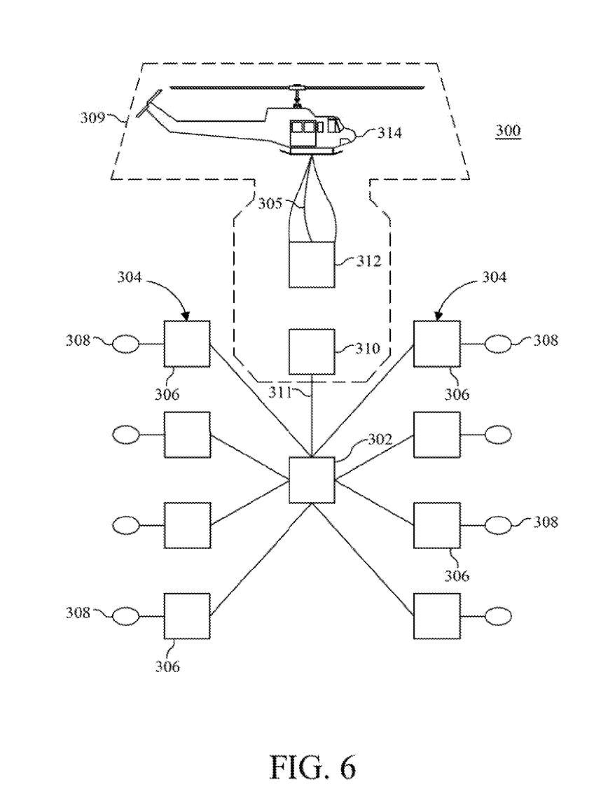

Referring to FIG. 6, exemplary embodiments are also directed to a seismic data acquisition system 300 that incorporates the portable charging system. The seismic data acquisition system includes ground equipment 304, where the ground equipment includes at least one surface unit or a plurality of surface units 306. Each surface unit is in communication with at least one seismic sensor 308 for obtaining seismic data. Various embodiments of the ground equipment, surface units and seismic sensors can be used with the portable charging system including cabled systems, cableless systems and autonomous nodes. At least one field battery 302 is provided in communication with one surface unit or the plurality of surface units to provide power to all of the surface units and seismic sensors.

The seismic data acquisition system incorporates the portable charging system 309 in communication with the field battery to charge the field battery. The portable charging system includes a first part 312 having an electrical power source 314, e.g., an engine of a helicopter through a power cable 305, and a first housing having a first three dimensional shape. As illustrated, the first housing is transported by the helicopter. The portable charging system also includes a second part 310 that is separate from and independent of the first part. The second part is located in the field adjacent the existing field battery and includes a second housing having a second three dimensional shape that is a complementary shape to the first three dimensional shape and a charge storage unit or battery having an ultracapacitor. This charge storage unit or battery is disposed in the second housing and in communication with the field battery, for example through a wired connection 311. The first three dimensional shape mates with the second three dimensional shape to align the first part with the second part to facilitate wireless transfer of power from the electrical power source to the charge storage unit or battery for storage in the ultracapacitor.

The portable charging system can be used to supply power to any remotely deployed and located field equipment by placing the second part in communication with this field equipment. The remotely deployed and located field equipment is not limited to filed equipment associated with seismic data acquisition and can be any type of equipment. In addition, the portable charging system can be used to recharge the batteries in the remotely deployed field equipment. In one embodiment, the remotely deployed field equipment can be customized to include the charge storage unit and the second three dimensional shape. Suitable field equipment include, but are not limited to, remotely deployed survey equipment.

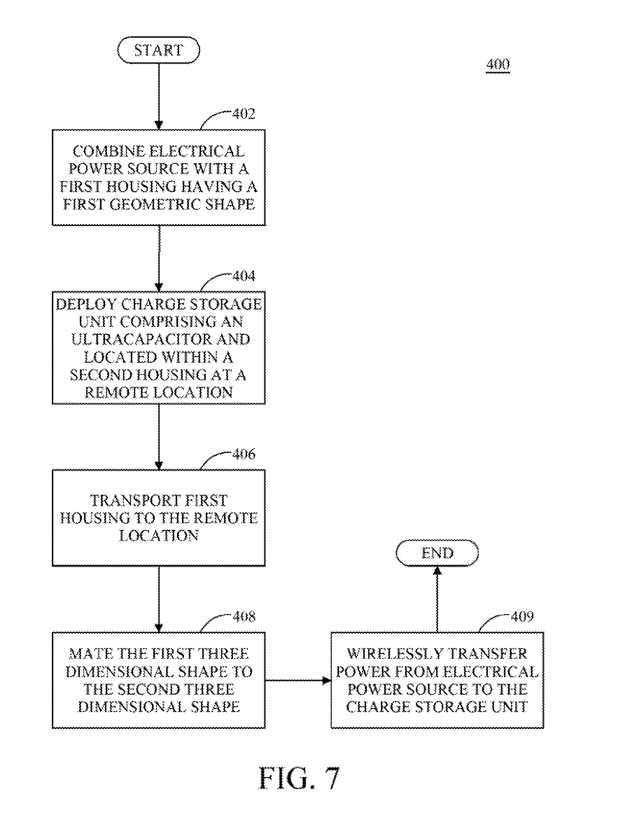

Referring to FIG. 7, exemplary embodiments are also directed to a method for using the portable charging system for charging remotely deployed field equipment 400. According to this method, an electrical power source is combined with a first housing having a first three dimensional shape 402. In addition, a first wireless communication module can be incorporated into the first house as well as first electrical coil that is in communication with the electrical power source. A charge storage unit is deployed at a remote location 404. This charge storage unit contains an ultracapacitor and is disposed within a second housing having a second three dimensional shape. In addition, a second wireless communication module can be incorporated into the second housing as well as a second electrical coil that is in communication with the charge storage unit. In one embodiment, the charge storage unit is deployed into the remote location and placed in communication with remotely deployed field equipment to supply power to the field equipment.

The first housing is transported to the remote location 406. The first housing can be transported by vehicle, carried by hand or pulled on a sled. In addition, multiple modes of transport can be used to bring the first housing to the remote location. In one embodiment, the first housing is tethered to a helicopter, which transports to the first housing to the remote location and also serves as the electrical power source.

Having transported the first housing to the remote location, the first three dimensional shape is mated with the second three dimensional shape 408. This facilitates wireless transfer of power from the electrical power source to the charge storage unit 409 for storage in the ultracapacitor. Therefore, the portable charging unit is used to charge remotely deployed field equipment that are located within the second housing or that are in communication with the charge storage unit. Proper field alignment between the first and second three dimensional shapes is simplified by forming the first three dimensional shape with rotational symmetry about a first axis, and the second three dimensional shape with rotational symmetry about a second axis. Therefore, mating the first three dimensional shape with the second three dimensional shape aligns the first axis with the second axis to form a common axis.

In one embodiment, data are also exchanged between the first wireless communication module and the second wireless communication module when the first three dimensional shape is mated with the second three dimensional shape. In addition, the first three dimensional shape with the second three dimensional shape, for example when forming the common axis, coaxially align the first electrical coil and the second electrical coil to transfer wirelessly power through resonant inductive coupling when the first three dimensional shape is mated with the second three dimensional shape.

Although the features and elements of the present exemplary embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

1. A portable charging system comprising:
a first part comprising:
an electrical power source; and
a first housing having a first three dimensional shape; and
a second part separate from and independent of the first part, the second part comprising:
a second housing having a second three dimensional shape comprising a complementary shape to the first three dimensional shape; and
a charge storage unit comprising an ultracapacitor and disposed in the second housing; and
wherein the first three dimensional shape mates with the second three dimensional shape to align the first part with the second part to facilitate wireless transfer of power from the electrical power source to the charge storage unit for storage in the ultracapacitor.

2. The portable charging system of claim 1, wherein:
the first part further comprises a first electrical coil disposed in the first housing and in communication with the electrical power source;
the second part further comprises a second electrical coil disposed in the second housing and in communication with the charge storage unit; and
the first electrical coil and the second electrical coil to transfer wirelessly power through inductive coupling when the first three dimensional shape is mated with the second three dimensional shape.

3. The portable charging system of claim 2, wherein the first electrical coil and the second electrical coil comprise resonant circuits that resonate at a common frequency.

4. The portable charging system of claim 2, wherein the first electrical coil is coaxial with the second electrical coil and the second electrical coil is nested within the first electrical coil when the first three dimensional shape is mated with the second three dimensional shape.

5. The portable charging system of 2, wherein the second electrical coil comprises a magnetic core.

6. The portable charging system of claim 1, wherein the second three dimensional shape is at least partially disposed within the first three dimensional shape when the first three dimensional shape is mated with the second three dimensional shape

7. The portable charging system of 1, wherein:
the first three dimensional shape comprises rotational symmetry about a first axis; and
the second three dimensional shape comprises rotational symmetry about a second axis, the first axis and the second axis forming a common axis when the first three dimensional shape is mated with the second three dimensional shape.

8. The portable charging system of claim 7, wherein the first three dimensional shape and the second three dimensional shape comprise rotational symmetry with respect to any angle of rotation.

9. The portable charging system of claim 7, wherein mating of the first three dimensional shape with the second three dimensional shape and wireless transfer of power from the electrical power source to the charge storage unit is agnostic to rotation of the first part with respect to the second part about the common axis.

10. The portable charging system of claim 1, wherein the second part further comprises an electrochemical cell in communication with the ultracapacitor, the ultracapacitor charging the electrochemical cell.

11. The portable charging system of claim 1, wherein the electrical power source comprises a generator, aircraft power, a battery, an alternator, a fuel cell, a piezoelectric generator, a wave generator, a thermoelectric generator, a photovoltaic cell or combinations thereof.

12. The portable charging system of claim 1, wherein:
the first part further comprises a first wireless communication module disposed in the first housing; and
the second part further comprises a second wireless communication module disposed in the second housing, the first wireless communication module exchanging data with the second wireless communication module when the first three dimensional shape is mated with the second three dimensional shape.

13. The portable charging system of claim 1, wherein the first and second wireless communication modules comprise radio wave communication modules, ultrasonic communication modules, inductive coupling communication modules, optical communication modules, cellular network communication modules or acoustic communication modules.

14. The portable charging system of claim 1, wherein the charge storage unit in the second part is in communication with remotely deployed field equipment to provide power to the field equipment.

15. The portable charging system of claim 1, wherein the charge storage unit in the second part is in communication with a field battery in a seismic data acquisition system to charge the field battery, the field battery in communication with ground equipment in the seismic data acquisition system to provide power to the ground equipment.

16. A seismic data acquisition system comprising:
ground equipment comprising at least one surface unit in communication with at least one seismic sensor for obtaining seismic data;
a field battery in communication with the surface unit to provide power to the surface unit; and
a portable charging system in communication with the field battery to charge the field battery, the portable charging system comprising:
a first part comprising:
an electrical power source; and
a first housing having a first three dimensional shape; and
a second part separate from and independent of the first part, the second part comprising:
a second housing having a second three dimensional shape that is a complementary shape to the first three dimensional shape; and
a charge storage unit comprising an ultracapacitor, disposed in the second housing and in communication with the field battery; and
wherein the first three dimensional shape mates with the second three dimensional shape to align the first part with the second part to facilitate wireless transfer of power from the electrical power source to the charge storage unit for storage in the ultracapacitor.

17. A method for charging remotely deployed field equipment, the method comprising:
combining an electrical power source with a first housing having a first three dimensional shape;
deploying a charge storage unit at a remote location, the charge storage unit comprising an ultracapacitor and disposed within a second housing having a second three dimensional shape;
transporting the first housing to the remote location; and
mating the first three dimensional shape with the second three dimensional shape 408 to facilitate wireless transfer of power from the electrical power source to the charge storage unit for storage in the ultracapacitor.

18. The method of claim 17, wherein:
the first three dimensional shape comprises rotational symmetry about a first axis;
the second three dimensional shape comprises rotational symmetry about a second axis; and
mating the first three dimensional shape with the second three dimensional shape further comprises aligning the first axis with the second axis to form a common axis when the first three dimensional shape is mated with the second three dimensional shape.

19. The method of claim 17, wherein the method further comprises:
incorporating a first wireless communication module in the first housing;
incorporating a second wireless communication module in the second housing; and
exchanging data between the first wireless communication module and the second wireless communication module when the first three dimensional shape is mated with the second three dimensional shape.

20. The method of claim 17, wherein:
the method further comprises:
incorporating a first electrical coil in the first housing in communication with the electrical power source; and
incorporating a second electrical coil in the second housing in communication with the charge storage unit; and
mating the first three dimensional shape with the second three dimensional shape further comprises coaxially aligning the first electrical coil and the second electrical coil to transfer wirelessly power through resonant inductive coupling when the first three dimensional shape is mated with the second three dimensional shape.
